(19) United States
(12) Patent Application Publication
(10) Pub. No.: US 2015/0039383 A1
(43) Pub. Date: Feb. 5, 2015

(54) Methods and Systems for a Product Selection Tool

(71) Applicant: LIFE TECHNOLOGIES CORPORATION, Carlsbad, CA (US)

(72) Inventors: Darren Thierry, Carlsbad, CA (US); Jingyi Yu, Carlsbad, CA (US); Karen Spinks, Cardiff by the Sea, CA (US)

(73) Assignee: LIFE TECHNOLOGIES CORPORATION, Carlsbad, CA (US)

(21) Appl. No.: 14/382,294

(22) PCT Filed: Jan. 25, 2013
(86) PCT No.: PCT/US2013/023299

§ 371 Date: Aug. 29, 2014

Related U.S. Application Data
(60) Provisional application No. 61/605,443, filed on Mar. 1, 2012.

(51) Int. Cl. G06Q 10/06

(52) U.S. Cl. CPC G06Q 10/0633
USPC 705/7.27

(57) ABSTRACT

A computer-implemented method for determining a desired product for performing a workflow is provided. The method includes receiving a selection of a desired workflow from a user. The desired workflow includes a set of steps including at least one step. The method includes receiving a selection of a step from the set of steps from the user, then displaying a plurality of product categories associated with the selected step. The method further includes receiving a selection of a product category of the plurality of product categories from the user, then displaying a plurality of products associated with the selected product category, and a plurality of associated metrics associated with each of the products of the plurality of products. At least one of the associated metrics is determined from input from a plurality of users.

### CROSS-REFERENCE TO RELATED APPLICATIONS

This application claims the benefit of priority of U.S. Provisional Application No. 61/605,443, filed Mar. 1, 2012, which is incorporated herein by reference in its entirety.

### BACKGROUND

Use and implementation of online shopping is increasing every day. Users, consumers, customers, salespeople, shoppers, buyers, and clients use online shopping websites to select desired products, such as clothing, books, household items, gifts, health and beauty products, for example, to purchase. Users will often use online shopping websites to search for a specific product they desire, such as a specific book.

However, when a user is trying to perform a specific task, the user may be unaware of the specific product they need to complete the task. Furthermore, the user may also need another reference source to understand the steps needed to complete the task. As such, the user may need to research both the process to complete the task and the products needed for each step of the process. An example of a process may be a scientific experiment workflow.

### SUMMARY

In one exemplary embodiment, a system for determining a desired product for performing a workflow is provided. The system includes a processor and a memory. The memory is encoded with instructions, executable by the processor. The instructions include instructions for receiving a selection of a desired workflow from a user. The desired workflow includes a set of steps including at least one step. The instructions further include instructions for receiving a selection of a step from the set of steps from the user and displaying a plurality of product categories associated with the selected step. The instructions further include instructions for receiving a selection of a product category of the plurality of product categories from the user, displaying a plurality of products associated with the selected product category, and displaying a plurality of associated metrics associated with each of the products of the plurality of products. At least one of the associated metrics is determined from input from a plurality of users.

In another exemplary embodiment, a computer-implemented method for determining a desired product for performing a workflow is provided. The method includes receiving a selection of a desired workflow from a user. The desired workflow includes a set of steps including at least one step. The method includes receiving a selection of a step from the set of steps from the user, then displaying a plurality of product categories associated with the selected step. The method further includes receiving a selection of a product category of the plurality of product categories from the user, then displaying a plurality of products associated with the selected product category, and a plurality of associated metrics associated with each of the products of the plurality of products. At least one of the associated metrics is determined from input from a plurality of users.

In yet another embodiment, a tangible computer-readable storage medium encoded with instructions, executable by a processor, for determining a desired product for performing a workflow is provided. The instructions include instructions for receiving a selection of a desired workflow from a user. The desired workflow includes a set of steps including at least one step. The instructions further include instructions for receiving a selection of a step from the set of steps from the user and displaying a plurality of product categories associated with the selected step. The instructions further include instructions for receiving a selection of a product category of the plurality of product categories from the user, displaying a plurality of products associated with the selected product category, and displaying a plurality of associated metrics associated with each of the products of the plurality of products. At least one of the associated metrics is determined from input from a plurality of users.

### DESCRIPTION OF THE FIGURES

FIG. 1 is a block diagram that illustrates a computer system, upon which embodiments of the present teachings may be implemented;

FIG. 2 is a block diagram that illustrates a distributed network system, upon which embodiments of the present teachings may be implemented;

FIG. 3 illustrates an exemplary user interface for determining a product selection;

FIG. 4 illustrates an exemplary user interface displaying a workflow according to various embodiments described herein;

FIG. 5 illustrates an exemplary user interface displaying a workflow according to various embodiments described herein;

FIG. 6 illustrates an exemplary user interface displaying a workflow according to various embodiments described herein;

FIG. 7 illustrates an exemplary user interface displaying a workflow according to various embodiments described herein;

FIG. 8 illustrates an exemplary user interface displaying a workflow according to various embodiments described herein;

FIG. 9 illustrates an exemplary user interface displaying a workflow according to various embodiments described herein;

FIG. 10 illustrates an exemplary user interface displaying a workflow according to various embodiments described herein;

FIG. 11 illustrates an exemplary user interface displaying a workflow according to various embodiments described herein;

FIG. 12 illustrates an exemplary user interface displaying a workflow according to various embodiments described herein;

FIG. 13 illustrates an exemplary user interface displaying a workflow according to various embodiments described herein;

FIG. 14 illustrates an exemplary user interface displaying a workflow according to various embodiments described herein;

FIGS. 15A-15D illustrate an exemplary display of possible desired products according to various embodiments described herein; and

FIG. 16 illustrates an exemplary user interface displaying competitive look-up tool according to various embodiments described herein;

FIG. 17 illustrates an exemplary user interface displaying competitive mash-up tool according to various embodiments described herein;

FIG. 18 illustrates an exemplary workflow in which embodiments described herein may be implemented; and

FIG. 19 illustrates an exemplary user interface for auto-gap identification according to various embodiments described herein.

### DETAILED DESCRIPTION

To provide a more thorough understanding of the present invention, the following description sets forth numerous specific details, such as specific configurations, parameters, examples, and the like. It should be recognized, however, that such description is not intended as a limitation on the scope of the present invention, but is intended to provide a better description of the exemplary embodiments.

An online shopping tool that includes a workflow identification feature and a product identification feature are useful for users shopping for, or researching products to perform a specific workflow. The workflows may relate to, but are not limited to fields such as the scientific fields for performing experiments. Examples of workflows that may be included are workflows related to custom vector research areas, sequencing, agriculture biotechnology, cancer research, epigenics, drug discovery, and pathogen detection. It should be recognized that the present teachings may be implemented with any field that includes processes or workflows.

Further, various embodiments described herein may be used by users, consumers, clients, salespeople, sellers, customers, and buyers, among other people. For example, various embodiments described herein may be used by a sales force of a company to assist its customers in selecting products or to suggest workflows to accomplish a desired task.

As another example, various embodiments of the present teachings may allow a supply center to select the optimal quantities of products to stock based on customer use. Moreover, by analyzing historical data, users of the system according to various embodiments may be able to determine where there are cross-sell and up-sell opportunities in the workflows.

In yet another example, various embodiments described herein may be used to research competitive products. More particularly, a user may be able to determine a company's product needed to perform a process, task, experiment, or step. The user may then be able to view corresponding or similar products available from the company's competitors. This aspect may be used by a company to identify opportunity to drive share gains.

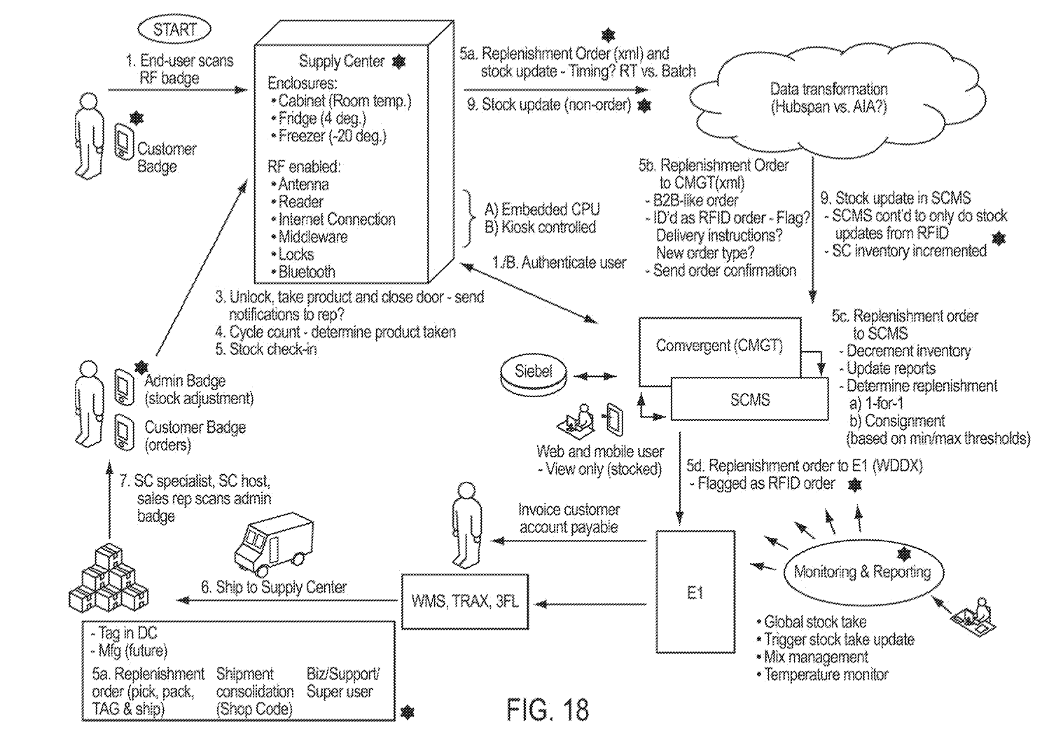

As such, methods and systems according to various embodiments described herein may be implemented in a variety of steps in a product workflow from supply center to customer, such as in the workflow illustrated in FIG. 18.

The applications that can use the embodiments described herein include, but are not limited to: SCMS End-User Promo, Email Blasts, Online Marketing, Instrument/Reagent Attachment, New Starts, On-product Marketing, Inside Sales, Account Planning, Customer Business Reviews, and Web Cross-Selling.

As mentioned above, embodiments of the present teachings may be used in fields other than the scientific fields. Any field that includes workflows or processes may implement the systems and methods described herein. For example, various embodiments described herein may be used in manufacturing, automotive, engineering, managerial, event planning, human resources, agricultural, construction, and high tech fields, for example.

As described in further detail below, embodiments of the present disclosure may be implemented to be an online tool that is accessed by the users. Thus, embodiments described herein may be implemented by personal computers, servers and databases in a distributed system over a network, tablet computers, and smart phones, for example.

### Computer-Implemented System

Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on non-transitory computer-readable media. Some other processes can be implemented using analog circuitry, as is well known to one of ordinary skill in the art. Additionally, memory or other storage, as well as communication components, may be employed in embodiments of the invention.

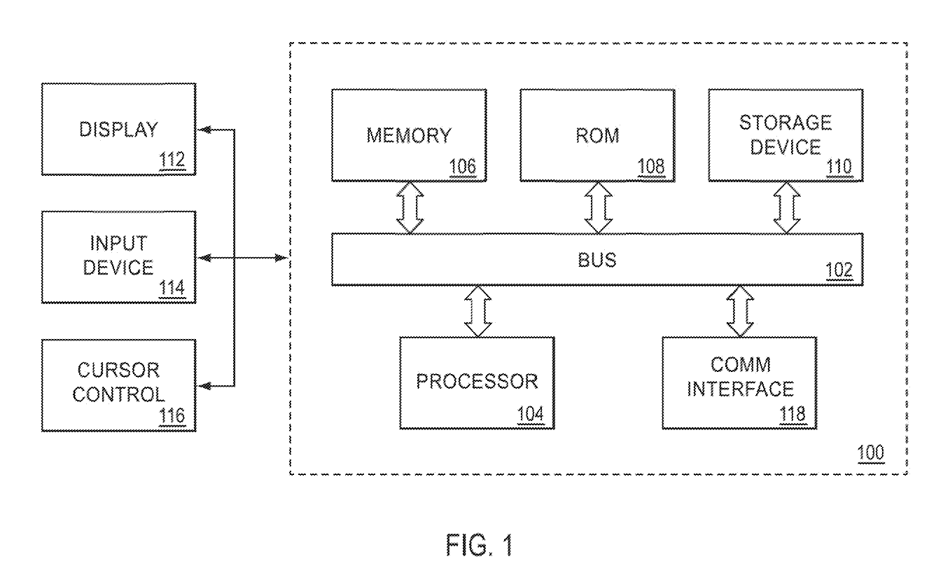

FIG. 1 is a block diagram that illustrates a computer system 100 that may be employed to carry out processing functionality, according to various embodiments. Instruments to perform experiments may be connected to the exemplary computing system 100. Computing system 100 can include one or more processors, such as a processor 104. Processor 104 can be implemented using a general or special purpose processing engine such as, for example, a microprocessor, controller or other control logic. In this example, processor 104 is connected to a bus 102 or other communication medium.

Further, it should be appreciated that a computing system 100 of FIG. 1 may be embodied in any of a number of forms, such as a rack-mounted computer, mainframe, supercomputer, server, client, a desktop computer, a laptop computer, a tablet computer, hand-held computing device (e.g., PDA, cell phone, smart phone, palmtop, etc.), cluster grid, netbook, embedded systems, or any other type of special or general purpose computing device as may be desirable or appropriate for a given application or environment. Additionally, a computing system 100 can include a conventional network system including a client/server environment and one or more database servers, or integration with LIS/LIMS infrastructure. A number of conventional network systems, including a local area network (LAN) or a wide area network (WAN), and including wireless and/or wired components, are known in the art. Additionally, client/server environments, database servers, and networks are well documented in the art. According to various embodiments described herein, computing system 200 may be configured to connect to one or more servers in a distributed network. Computing system 200 may receive information or updates from the distributed network. Computing system 200 may also transmit information to be stored within the distributed network that may be accessed by other clients connected to the distributed network.

Computing system 100 may include bus 102 or other communication mechanism for communicating information, and processor 104 coupled with bus 102 for processing information.

Computing system 100 also includes a memory 106, which can be a random access memory (RAM) or other dynamic memory, coupled to bus 102 for storing instructions to be executed by processor 104. Memory 106 also may be used for storing temporary variables or other intermediate information during execution of instructions to be executed by processor 104. Computing system 100 further includes a read only memory (ROM) 108 or other static storage device coupled to bus 102 for storing static information and instructions for processor 104.

Computing system 100 may also include a storage device 110, such as a magnetic disk, optical disk, or solid state drive (SSD) is provided and coupled to bus 102 for storing information and instructions. Storage device 110 may include a media drive and a removable storage interface. A media drive may include a drive or other mechanism to support fixed or removable storage media, such as a hard disk drive, a floppy disk drive, a magnetic tape drive, an optical disk drive, a CD or DVD drive (R or RW), flash drive, or other removable or fixed media drive. As these examples illustrate, the storage media may include a computer-readable storage medium having stored therein particular computer software, instructions, or data.

In alternative embodiments, storage device 110 may include other similar instrumentalities for allowing computer programs or other instructions or data to be loaded into computing system 100. Such instrumentalities may include, for example, a removable storage unit and an interface, such as a program cartridge and cartridge interface, a removable memory (for example, a flash memory or other removable memory module) and memory slot, and other removable storage units and interfaces that allow software and data to be transferred from the storage device 110 to computing system 100.

Computing system 100 can also include a communications interface 118. Communications interface 118 can be used to allow software and data to be transferred between computing system 100 and external devices. Examples of communications interface 118 can include a modem, a network interface (such as an Ethernet or other NIC card), a communications port (such as for example, a USB port, a RS-232C serial port), a PCMCIA slot and card, Bluetooth, etc. Software and data transferred via communications interface 118 are in the form of signals which can be electronic, electromagnetic, optical or other signals capable of being received by communications interface 118. These signals may be transmitted and received by communications interface 118 via a channel such as a wireless medium, wire or cable, fiber optics, or other communications medium. Some examples of a channel include a phone line, a cellular phone link, an RF link, a network interface, a local or wide area network, and other communications channels.

Computing system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104, for example. An input device may also be a display, such as an LCD display, configured with touchscreen input capabilities. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane. A computing system 100 provides data processing and provides a level of confidence for such data. Consistent with certain implementations of embodiments of the present teachings, data processing and confidence values are provided by computing system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process states described herein. Alternatively hard-wired circuitry may be used in place of or in combination with software instructions to implement embodiments of the present teachings. Thus implementations of embodiments of the present teachings are not limited to any specific combination of hardware circuitry and software.

The term “computer-readable medium” and “computer program product” as used herein generally refers to any media that is involved in providing one or more sequences or one or more instructions to processor 104 for execution. Such instructions, generally referred to as “computer program code” (which may be grouped in the form of computer programs or other groupings), when executed, enable the computing system 100 to perform features or functions of embodiments of the present invention. These and other forms of non-transitory computer-readable media may take many forms, including but not limited to, non-volatile media, volatile media, and transmission media. Non-volatile media includes, for example, solid state, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on magnetic disk of a remote computer. The remote computer can load the instructions into its dynamic memory and send the instructions over a telephone line using a modem. A modem local to computing system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

### Distributed System

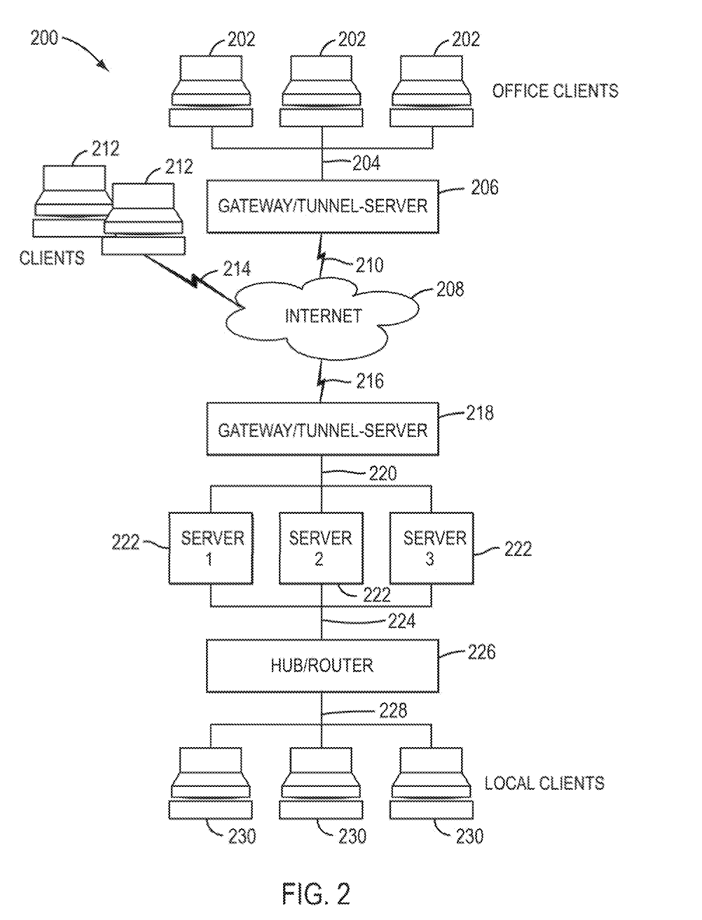

Some of the elements of a typical Internet network configuration 200 are shown in FIG. 2, wherein a number of client machines 202 possibly in a remote local office, are shown connected to a gateway/hub/tunnel-server/etc 210 which is itself connected to the internet 208 via some internet service provider (ISP) connection 210. Also shown are other possible clients 212 similarly connected to the internet 208 via an ISP connection 214, with these units communicating to possibly a central lab or office, for example, via an ISP connection 216 to a gateway/tunnel-server 218 which is connected 220 to various enterprise application servers 222 which could be connected through another hub/router 226 to various local clients 230. Any of these servers 222 could function as a development server for the analysis of potential content management and delivery design solutions as described in the present invention, as more fully described below.

### Workflows

As mentioned above, it may be useful for users of a system to be able to visualize a workflow to be able to know the steps of the process and then to find the products needed for each of the steps of the workflow. Having a tool to visualize the workflow and then to select the products needed for each step reduces or eliminates the need to look to other reference sources.

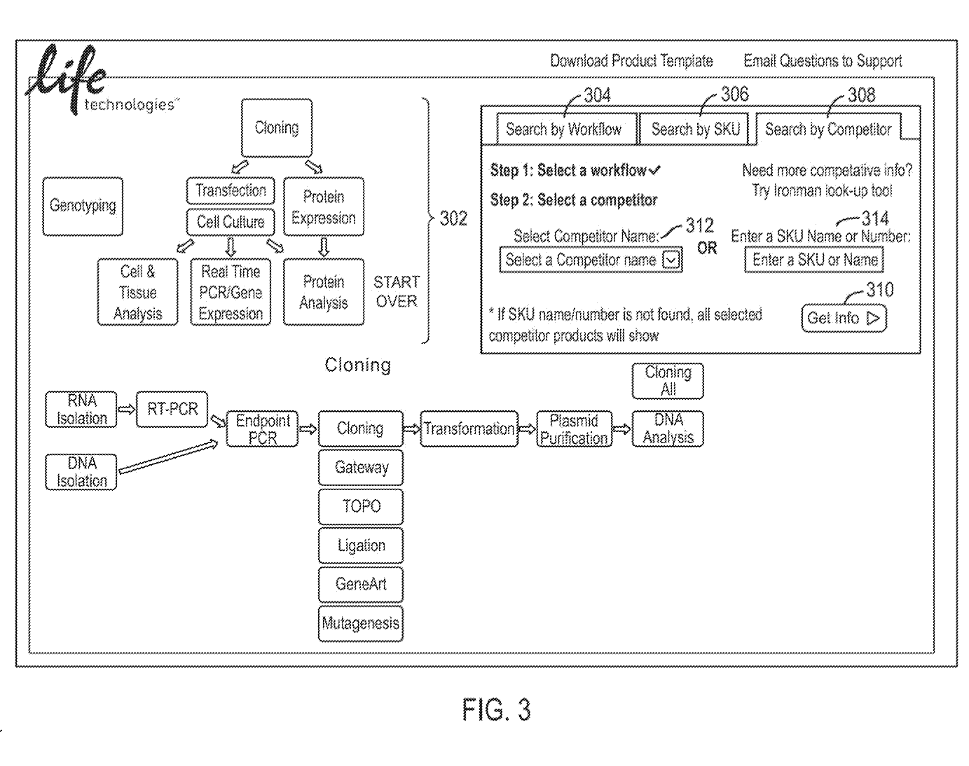

FIG. 3 illustrates an exemplary user interface displaying an exemplary workflow 302. In this example, workflow 302 is a high level workflow for a scientific process that is displayed on a user interface.

Exemplary workflow 302 includes steps of cloning, transfection, cell culture, protein expression, cell and tissue analysis, real time PCR/Gene expression, and protein analysis. Further, a user may select a step of workflow 302 to display more information about the workflow. For example, selecting a specific step may show the user a lower level workflow or sub-workflow associated with the specific step. The user may also be provided with a list of products or product categories that are associated with the step selected.

The user interface also displays options for different types of searches a user may perform, according to various embodiments. It should be recognized that the search functions described below are examples and other search functions may be available to the user according to other embodiments.

Users can search products by specific workflow by selecting the search by workflow option 304 within the user interface. Furthermore, selecting any workflow, or combination of workflows, and then selecting the get info button 310, displays the products that fall into the workflows selected by the user.

Furthermore, if the user does not know which workflow a product belongs to, the user may “Search By SKU” option 306, according to various embodiments. By using this function, the user can find the particular workflow associated with a specific product.

Another function, according to various embodiments described herein, is a competitor search option 308. A user may desire information about competitor's products. The user may select the “Search by Competitor” option 308 to enter the name the competitor. Additionally, the user may select the name of the competitor from a list of predetermined competitors in field 312. Using these functions, the user may be able to see and compare competitor's products and the associated workflows of the competitor's products. According to other embodiments, users may also have the option to search by a competitor SKU number or product name, as illustrated by field 314.

According to various embodiments, search results may further be filtered or sorted by ranking methods such as top sales or customer value continuum (CVC). Sales data associated with products may be also presented to a user. Products may be found by SKU number, SGN number, Ship-to number, or any other identifier that is associated with the product.

The combination of search functions and filters may give the users flexibility to create a variety of customized reports and identify opportunities for cross-selling and/or up-selling easily and quickly.

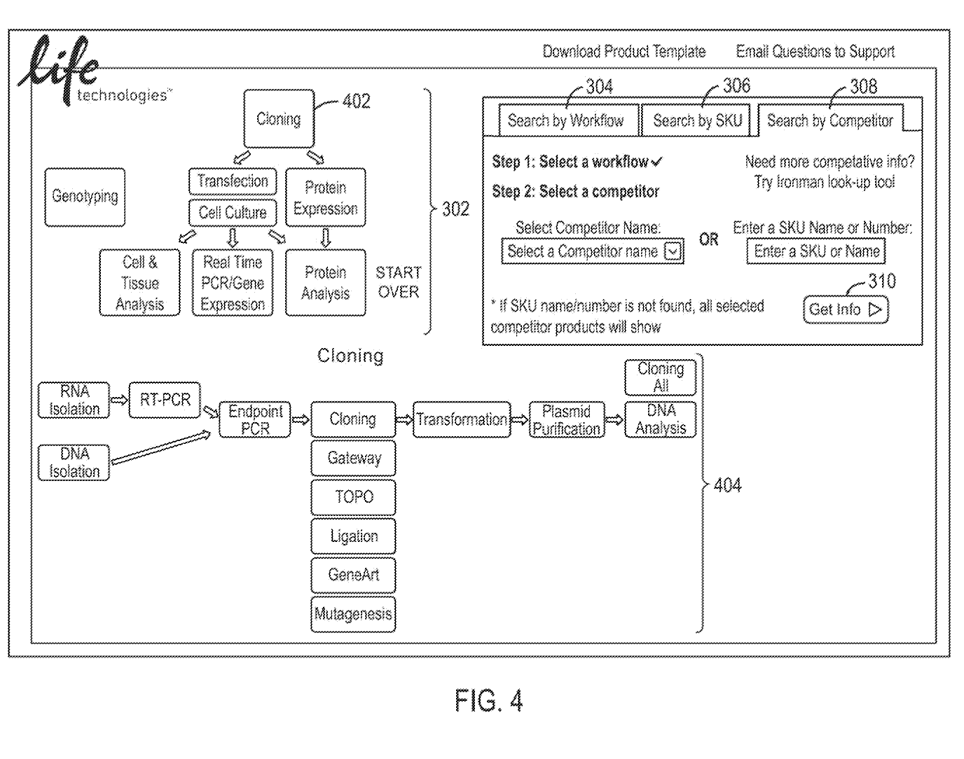

FIG. 4 illustrates the user interface when a user selects the cloning step 402 of workflow 302. In various embodiments, selection of steps in the high level workflow may yield a lower level workflow. The lower level workflow may also be referred to as a sub-workflow.

According to various embodiments, any workflow displayed illustrates specific steps required to complete the workflow. Furthermore, the workflow may also illustrate different product groups needed for a specific step of a workflow. Various lower level workflows, or sub-workflows may be needed if a particular workflow is more complex.

In this example, selecting cloning step 302 displays a lower level workflow 404 of cloning step 402. Lower level workflow 404 includes more detailed steps to performing a cloning task. Under the cloning step of the lower level workflow 404, product categories that a user may need to perform that step are displayed alongside the step to indicate to the user that these product categories (i.e., Gateway, TOPO, ligation, GeneArt, Mutagenesis) may be needed to perform this step.

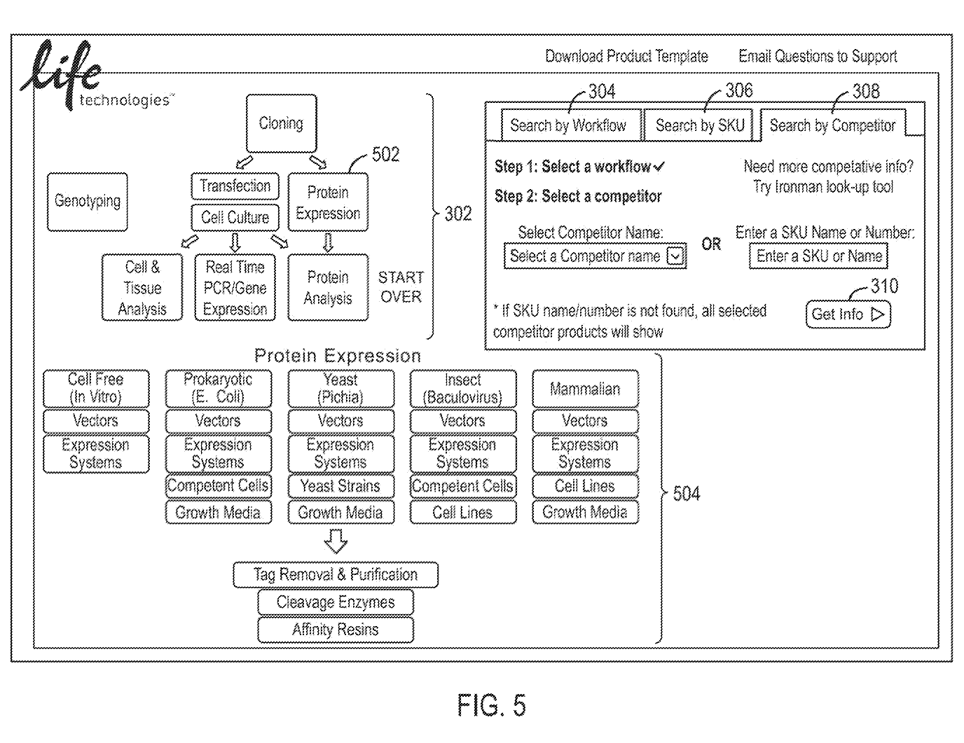

Similarly, FIGS. 5-13 illustrate examples of different lower level workflows that may be selected.

FIG. 5 illustrates a lower level workflow 504 of protein expression when the protein expression step 502 of the high level workflow 302 is selected.

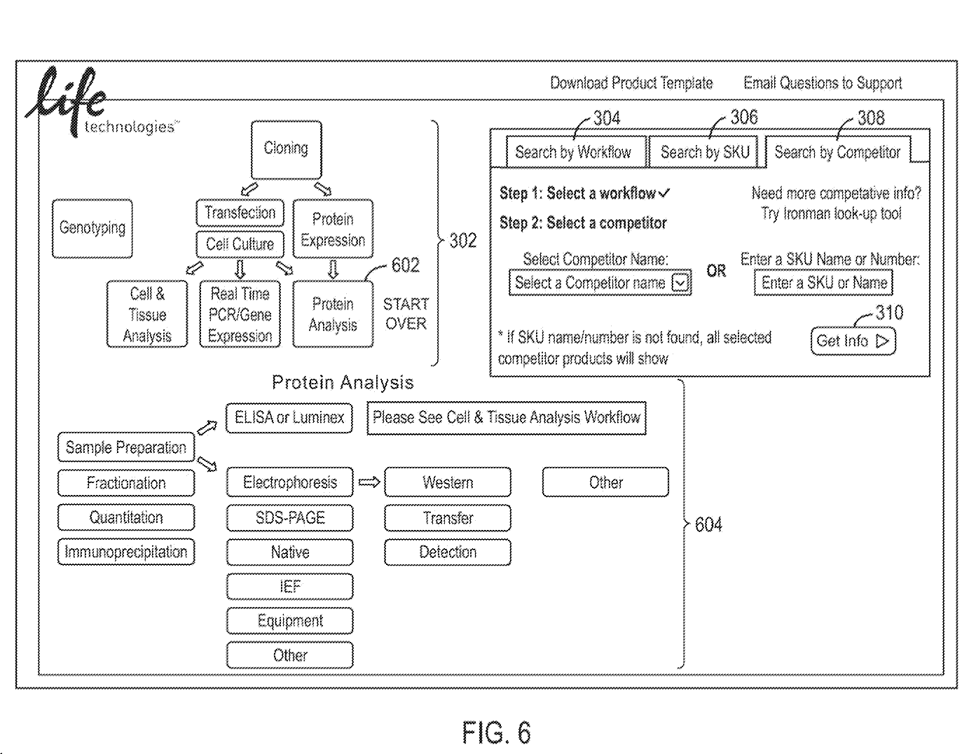

FIG. 6 illustrates a lower level workflow 604 of protein analysis when the protein analysis step 602 of the high level workflow 302 is selected.

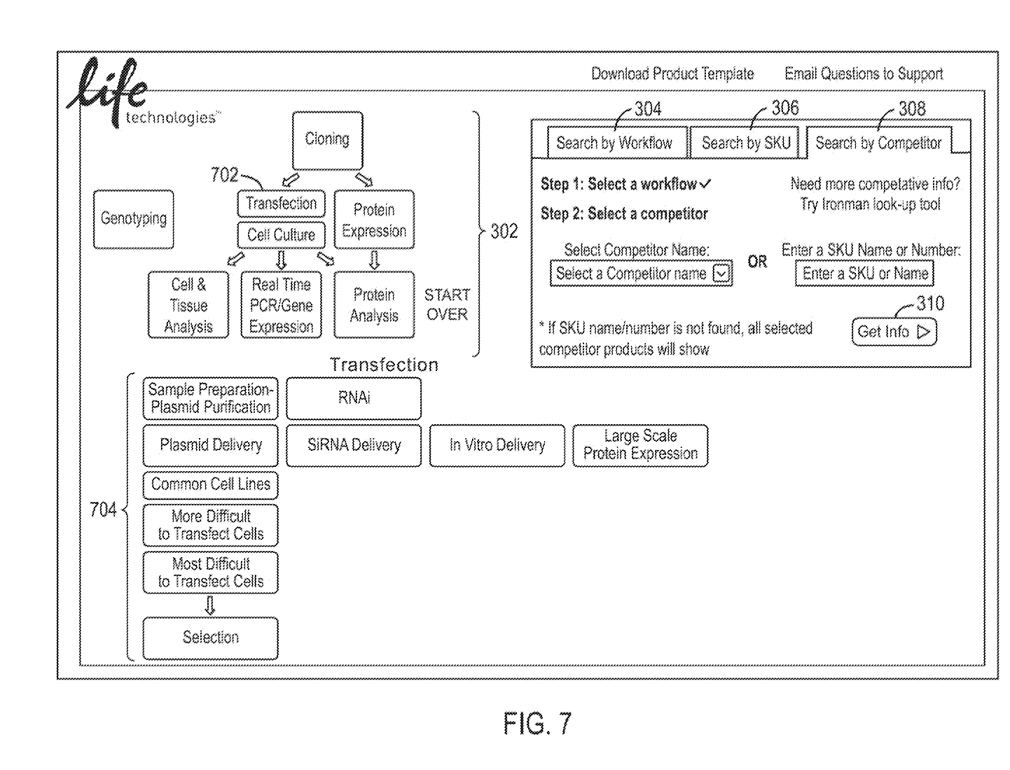

FIG. 7 illustrates a lower level transfection workflow 704 of transfection when the transfection step 702 of the high level workflow 302 is selected.

The lower level transfection workflow 704 has five product categories, which include: Plasmid Delivery, SiRNA Delivery, In Vivo Delivery, Large Scale Protein Expression and Sample Preparation Plasmid Purification.

The Plasmid Delivery category further includes three second level product categories: Common Cell lines, More Difficult to Transfect Cells, and Most Difficult to Transfect Cells.

Even further, second level product category Common Cell Lines includes two third level product categories (not shown): Preparation and Reagents. As an example, third level category Preparation has 27 products (or SKU numbers) associated with this category.

In other words, a user who desires to perform transfection may be able to see the process steps of the transfection workflow. Then, in researching the products needed for the plasmid delivery step, the user looks for common cell lines. In order to prepare her common cell line, embodiments described herein allow the user to view and select products to perform the plasmid delivery step.

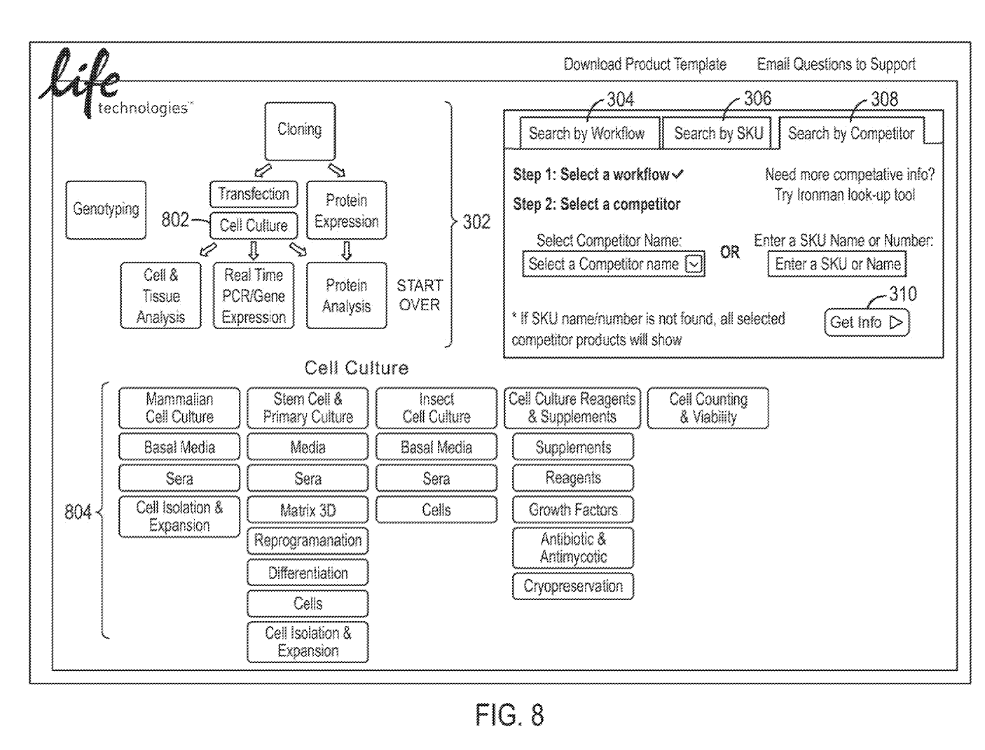

Similarly, FIGS. 8-14 illustrate other workflows that a user may research to determine and select products to perform process steps of the workflow.

FIG. 8 illustrates a lower level workflow 804 of cell culture when cell culture step 902 of the high level workflow 302 is selected.

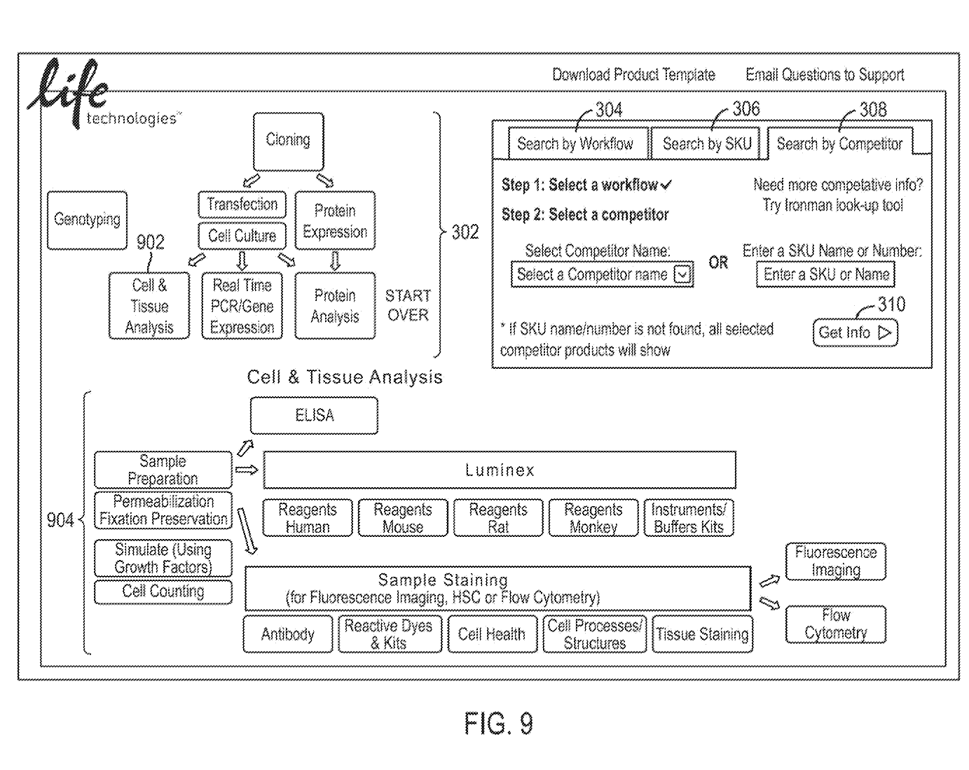

FIG. 9 illustrates a lower level workflow 904 of cell & tissue analysis when the protein cell & tissue analysis step 902 of the high level workflow 302 is selected.

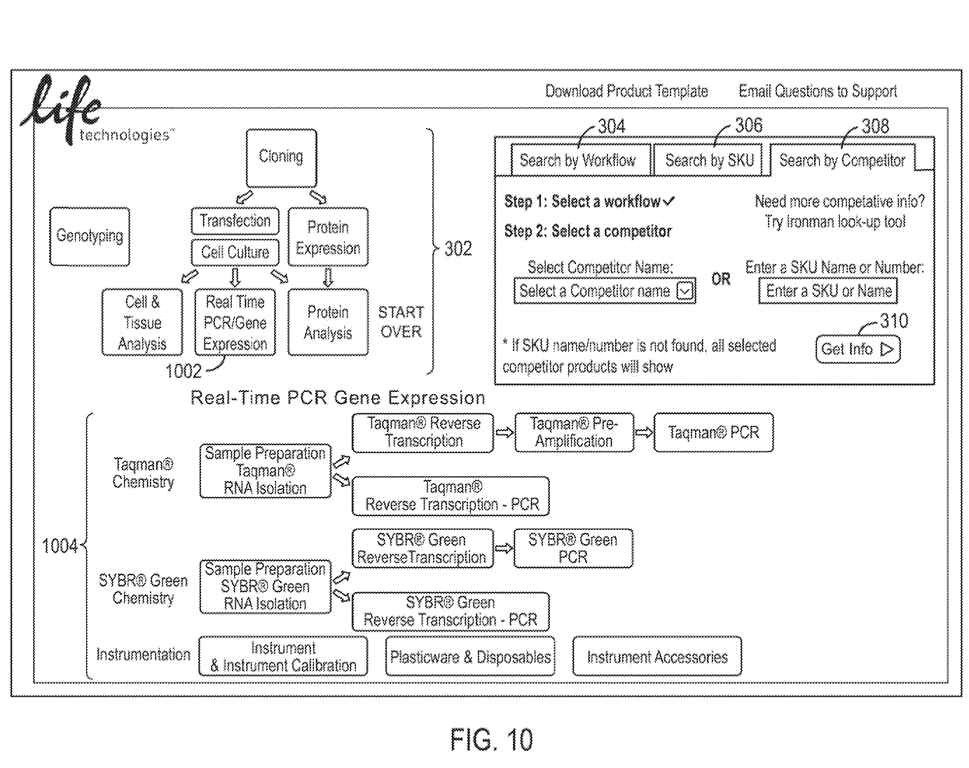

FIG. 10 illustrates a lower level workflow 1004 of real-time PCR gene expression when the real-time PCR gene expression step 1002 of the high level workflow 302 is selected.

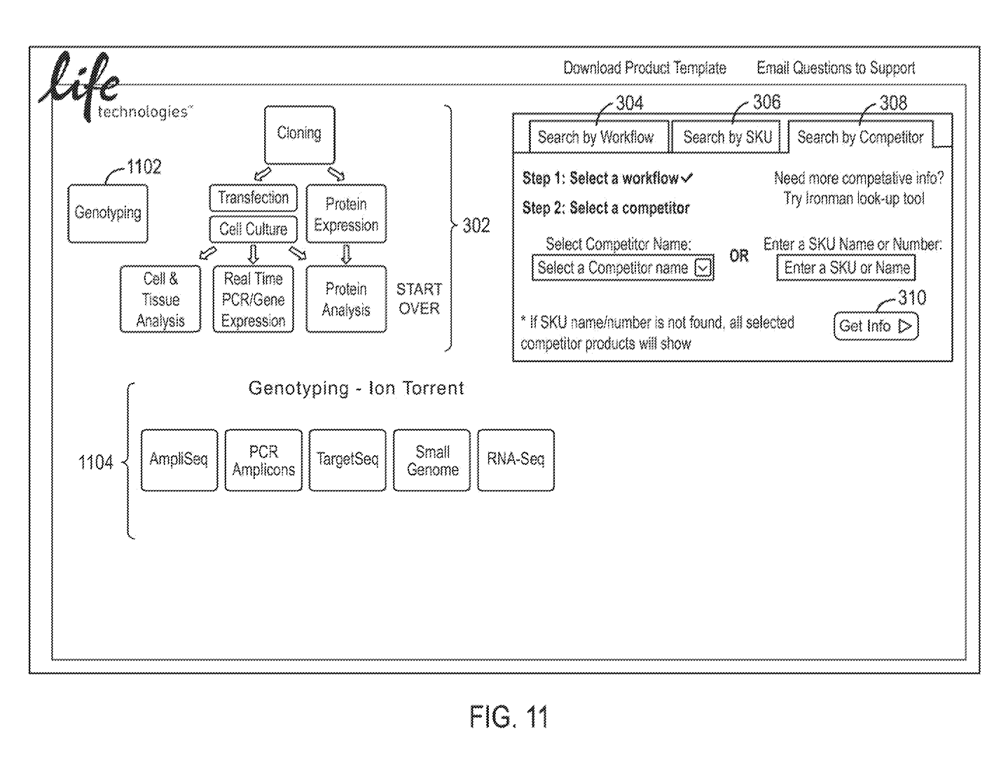

FIG. 11 illustrates a lower level workflow 1104 of genotyping when the genotyping step 1102 of the high level workflow 302 is selected.

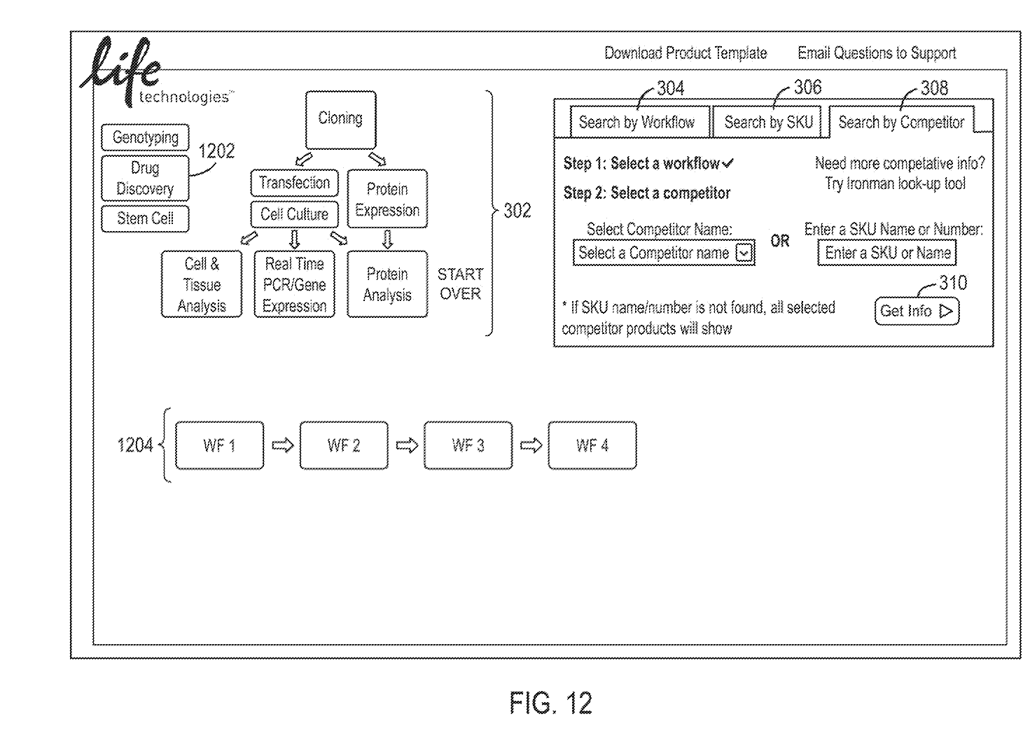

FIG. 12 illustrates a lower level workflow 1204 of drug discovery when the drug discovery step 1202 of the high level workflow 302 is selected.

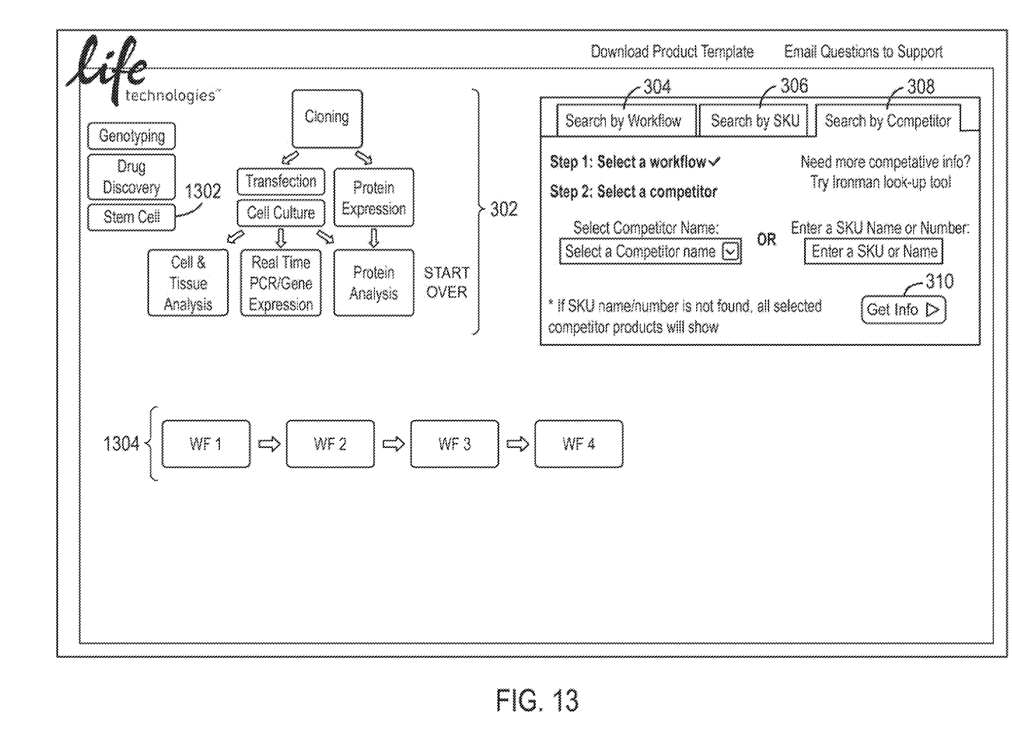

FIG. 13 illustrates a lower level workflow 1304 of stem cell when the stem cell step 1302 of the high level workflow 302 is selected.

As mentioned above, some product categories or workflow steps may include sub-workflows or sub-product categories. In this way, a user may continue to select a product category, for example, and be presented with sub-categories of products.

The examples described relate to scientific workflows, but one skilled in the art would recognize that embodiments of the present teachings can apply to workflows in other fields that have workflows.

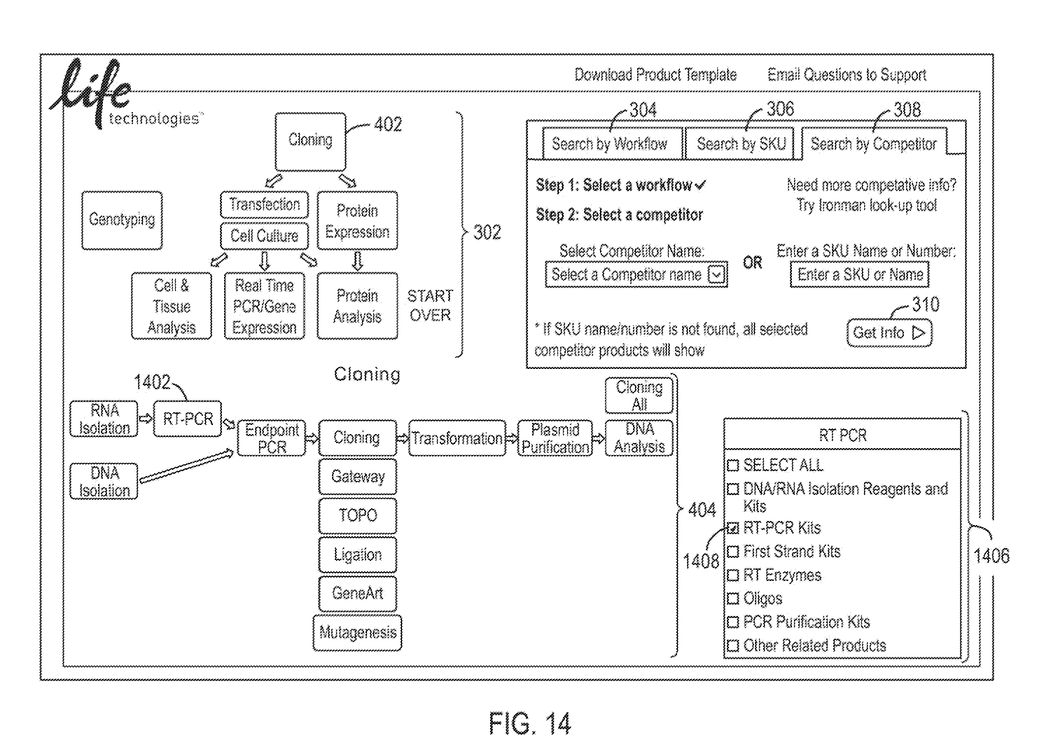

FIG. 14 illustrates the cloning sub-workflow 404 with reference to FIG. 4. In this example, a user has selected the RT-PCR step 1402 to find out more information related to the products associated with this step of the cloning sub-workflow 404. A menu of product categories 1406 is displayed to the user. The menu of product categories 1406 are product categories that are associated with the RT-PCR step 1402. For example, the product categories shown in the menu of product categories 1406 are DNA/RNA Isolation Reagents and Kits, RT-PCR Kits, First Strand Kits, RT Enzymes, Oligos, PCR Purification Kits, and Other Related Products. In this example, the RT-PCR Kits category 1408 is selected. As a result, the products associated with the RT-PCR Kits will be provided to the user.

### Product List Display

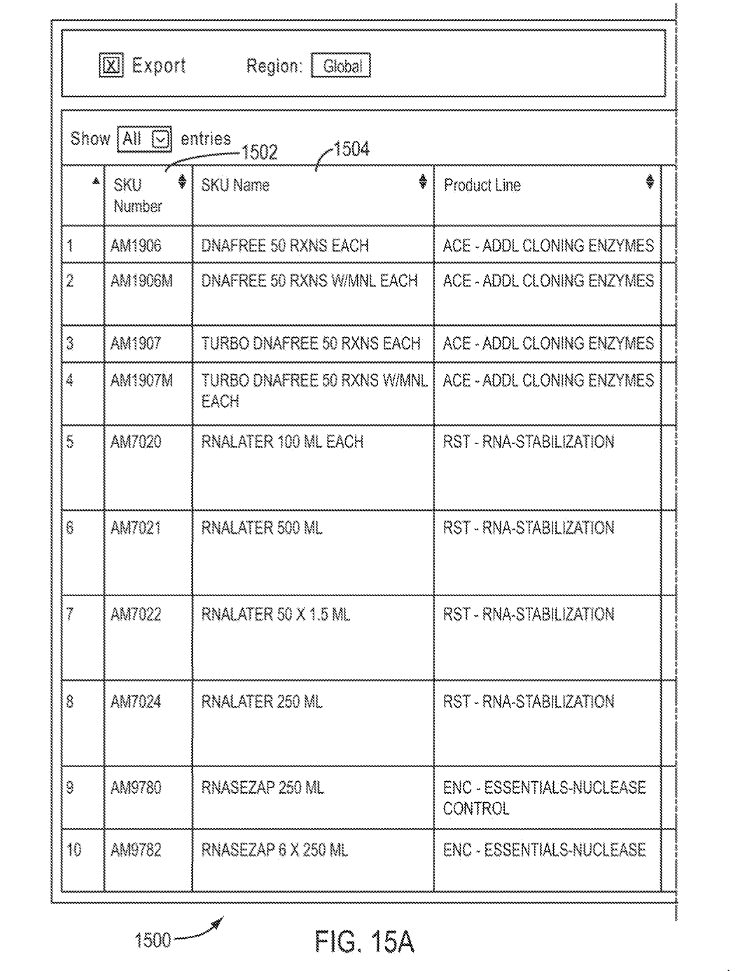

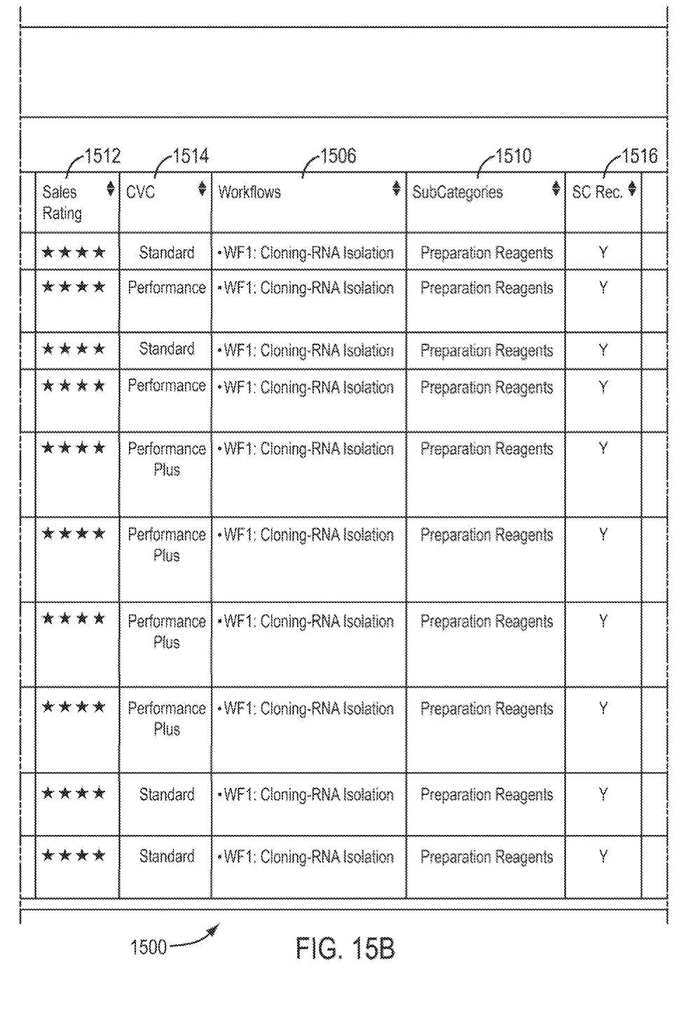

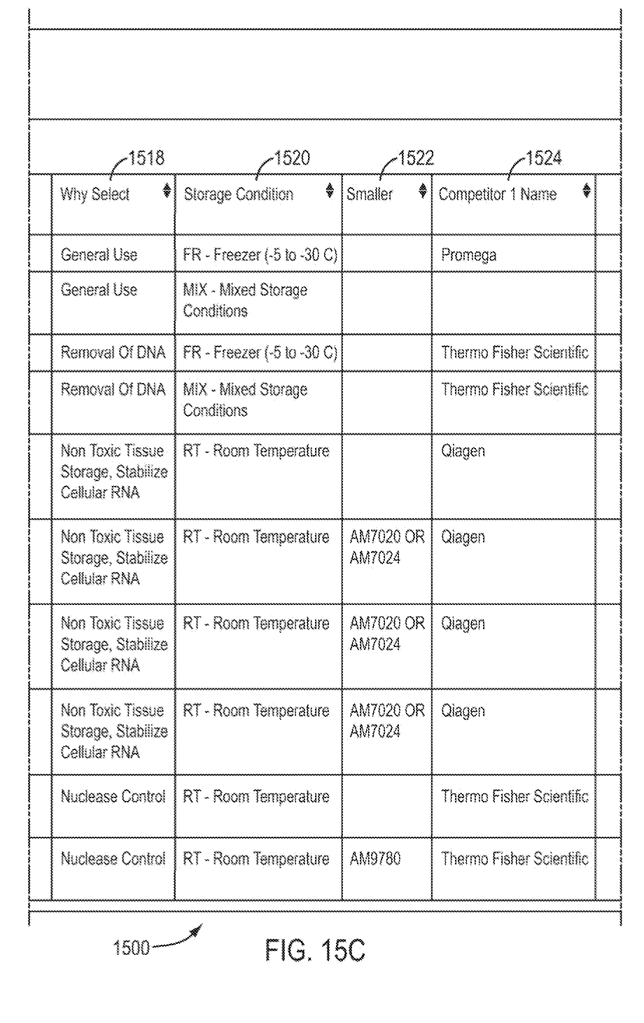

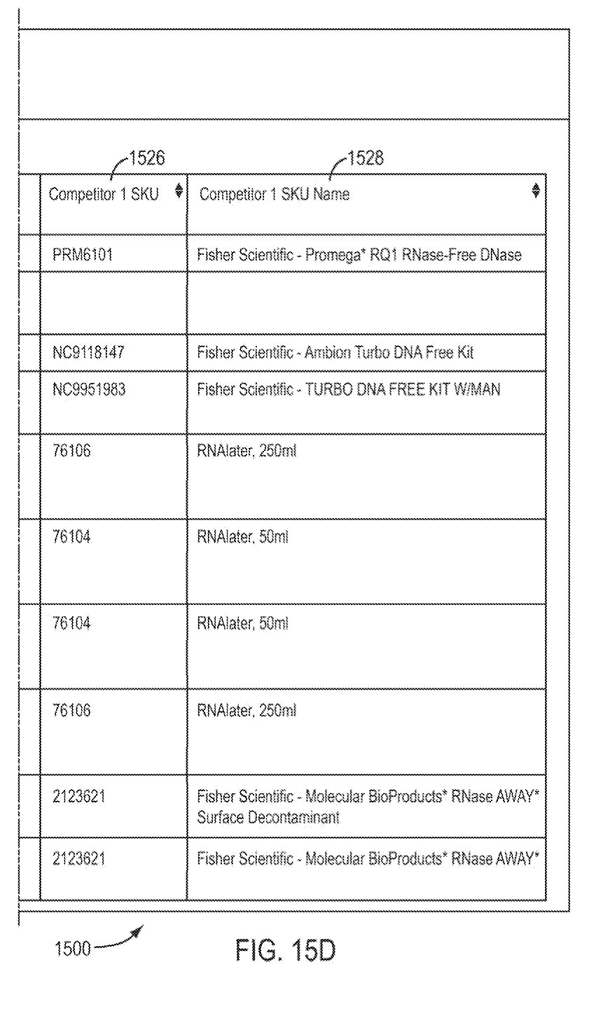

FIGS. 15A-15D illustrate an exemplary product list 1500 that may be generated based on the user selection of a particular workflow. Product list 1500 may be provided to the user by being displayed in the user interface according to some embodiments. Various embodiments allow a user to download the product list into a separate file that a user may save to a memory. For example, the user may download the file into an Excel document.

Product list 1500 may include a list of products and metrics associated with each product. According to various embodiments of the present teachings, the associated metrics may include ratings and popularity metrics, for example. These metrics may be determined by using user input from a plurality of users.

Another metric that is displayed may be the workflows where the product may be used. In some instances, a product may be used in multiple workflows. The metrics may indicate whether the product is used in a sub-workflow so that the user may understand what sub-steps the product may be used in.

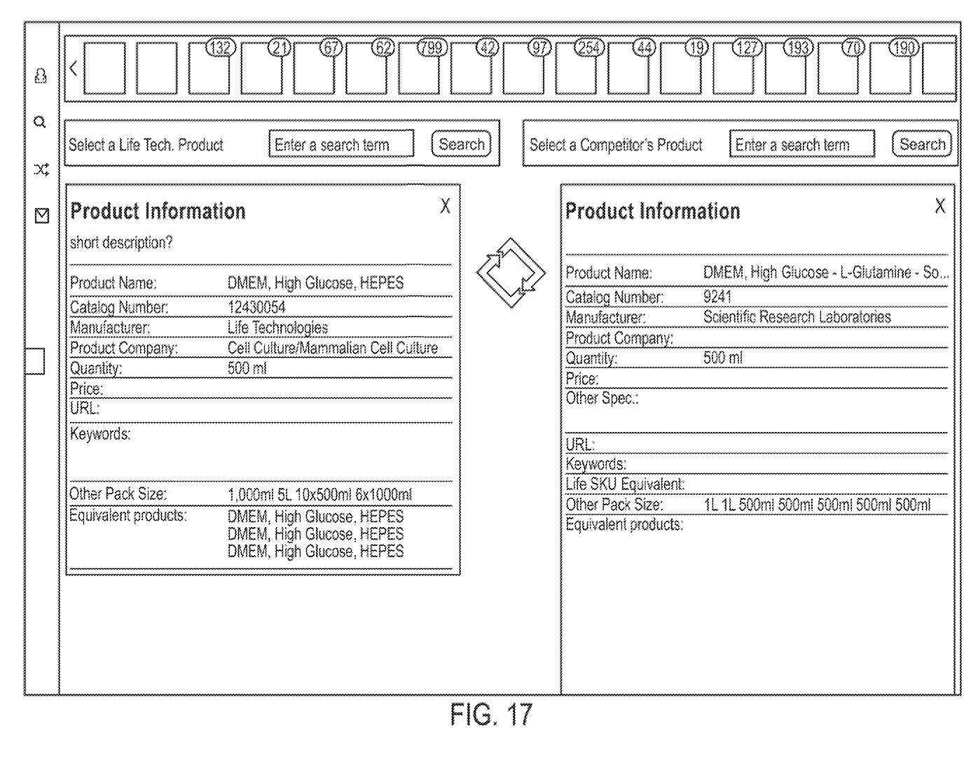

Furthermore, links to information on other web pages about a particular product may be included in product list 1500. For example, the company's product information page may be linked to product list 1500 so that a user desiring more information may easily access the product information page. An exemplary product information page is depicted in FIG. 17.

Associated metrics may include SKU number 1502, SKU name 1504, workflows 1506 associated with the product, subcategory 1510, rating by sales 1512, customer value 1514, supply center recommendation 1516, reasons for selection 1518, storage conditions 1520, smaller pack size of the product 1522, competitor names 1524, competitor SKU number 1526, and competitor SKU name 1528, for example.

The workflows 1506, the associated workflows that the product may be associated with are listed. The subcategory 1510 column displays the other sublevels of the workflow the product may be associated with.

The metric of rating by sales 1512 shows the products rating according to sales. In one example, the calculation to determine the rating by sales is 70% Rev+15% Quantity+15% Order frequency. The ratings may be represented by icons or symbols. For example, a high sales rating may be represented by “$$$$” while the lowest sales rating may be represented by “$”.

A customer value metric 1514 may also be displayed according to various embodiments. This metric may be based on the customer value continuum (CVC). This rating may be based on customer ratings and reviews. These can be shown in product list 1500 as “performance plus,” “performance,” “standard,” or “OK,” according to some embodiments.

Another metric of supply center recommended 1516 may also be displayed as a column in product list 1500. In this column, a “Y” may represent that the product is stocked in the supply center. If sales suggest that a product is now high selling, then an “N” in this column may change to “Y.”

Other metrics that may be included in a product list may include supply center revenue, supply center quantity, direct revenue, direct quantity, total revenue, and total quantity. Product list 1500 may also include notes relating to advantages of the product or why a customer would want to select some particular product over another product or competitor product.

As mentioned above, corresponding competitors, competitor products and names may also be displayed (1524, 1526, and 1528).

In various embodiments, shopping carts and web ordering functions may be included in the tool. Further, a usage checking system may be included to see the usage amount of specific users or groups of users.

Although various embodiments have been described with respect to certain exemplary embodiments, examples, and applications, it will be apparent to those skilled in the art that various modifications and changes may be made without departing from the present teachings.

### Competitive Look-Up Tool

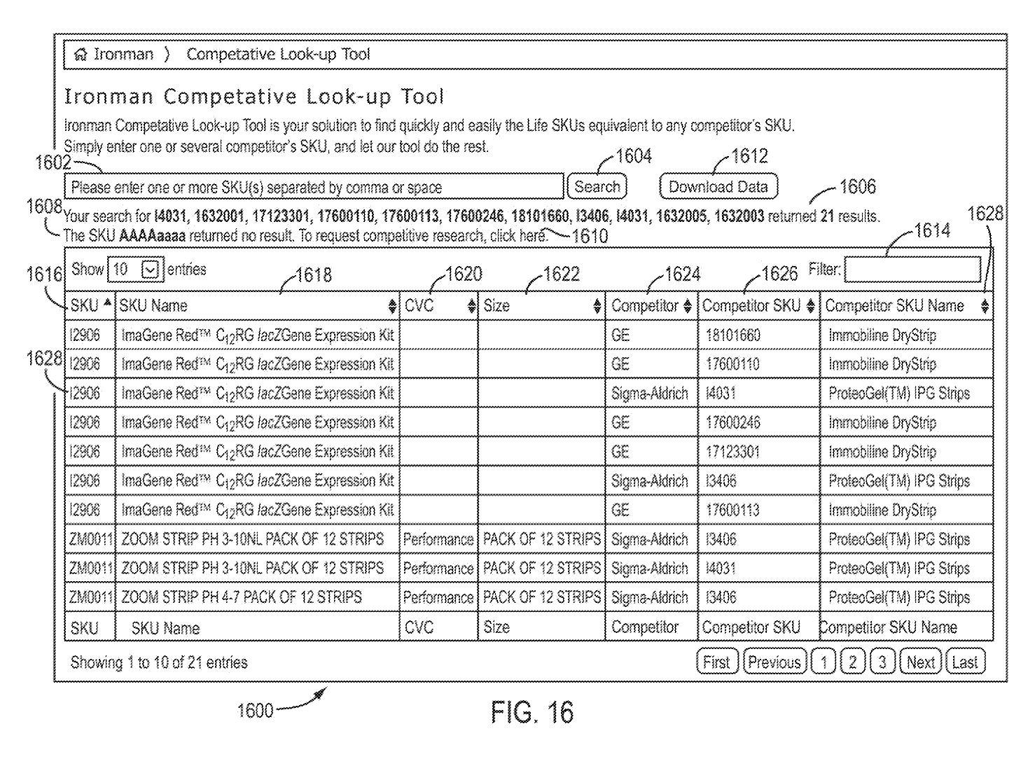

According to various embodiments, a product selection tool may be a competitive look-up tool. FIG. 16 illustrates an exemplary user interface displaying an exemplary competitive look-up tool 1600. Competitive look-up tool may be displayed to a user on a display such as a computer monitor, tablet computer, or mobile device, for example.

In this example, corresponding or similar products may be looked up and displayed to a user. The products displayed may be from a first company. Then, the user may be able to determine other products from a second company that correspond to the products from the first company. In some embodiments, corresponding products from a plurality of companies may be displayed to the user to compare. In some embodiments, a salesperson from one company may use the competitive look-up tool to determine corresponding products offered by competitor companies. A product may be looked up by a user by the product SKU. Further, the SKUs of corresponding products offered by other companies may also be displayed to the user.

Various embodiments allow a user to download the product list into a separate file that a user may save to a memory. For example, the user may download the file into an Excel document.

With reference to FIG. 16, exemplary competitive look-up tool 1600 illustrates a search box 1602 where a user may enter in one or more product numbers, such as SKUs, to search. The search is initiated by the activating the search button 1604. The number of results 1606 of corresponding products from a company is displayed after the search completes. Further, if no results are found for a certain product number, an indication 1608 is displayed to the user. More data associated with the product number can be requested to be provided to the user by activating button 1610. The data may also be downloaded by activating download data button 1612. The search results may also be filtered using input box 1614. Further, a user may select a product 1628 in the search results to display alternative pack sizes.

In various embodiments described herein, competitive product look-up tool 1600 may include a list of products in the search results and metrics associated with each product. According to various embodiments of the present teachings, the associated metrics may include ratings and popularity metrics, for example

Another metric that is displayed may be the workflows where the product may be used. In some instances, a product may be used in multiple workflows. The metrics may indicate whether the product is used in a sub-workflow so that the user may understand what sub-steps the product may be used in.

In various embodiments, associated metrics that may be provided to the user include SKU number 1616, SKU name 1618, customer value 1620, pack size 1622, competitor names 1624, competitor SKU number 1626, and competitor SKU name 1628, for example.

A customer value 1620 metric may also be displayed according to various embodiments. This metric may be based on the customer value continuum (CVC). This rating may be based on an aggregation of customer ratings and reviews. These can be shown in product list 1600 as “performance plus,” “performance,” “standard,” or “OK,” according to some embodiments. Further, corresponding competitor company names, competitor company product numbers and product names may also be displayed (1624, 1626, and 1628).

In various embodiments, shopping carts and web ordering functions may be included with the product selection tool. Further, a usage checking system may be included to see the usage amount of specific users or groups of users.

FIG. 18 illustrates an exemplary workflow in which embodiments described herein may be implemented. Product selection tools according to various embodiments described herein may be used in various steps shown in the exemplary workflow of FIG. 18. Furthermore, updated information from the supply center may be used in the product selection tools to give real-time product stock information, for example.

### Auto-Gap Identification

It may be useful for users of the product selection tool to be able to visualize a combination of products that customers are not purchasing, quantify the value of these products and display visual cues for largest areas of low product sales. These areas of low product sales are referred to as gaps.

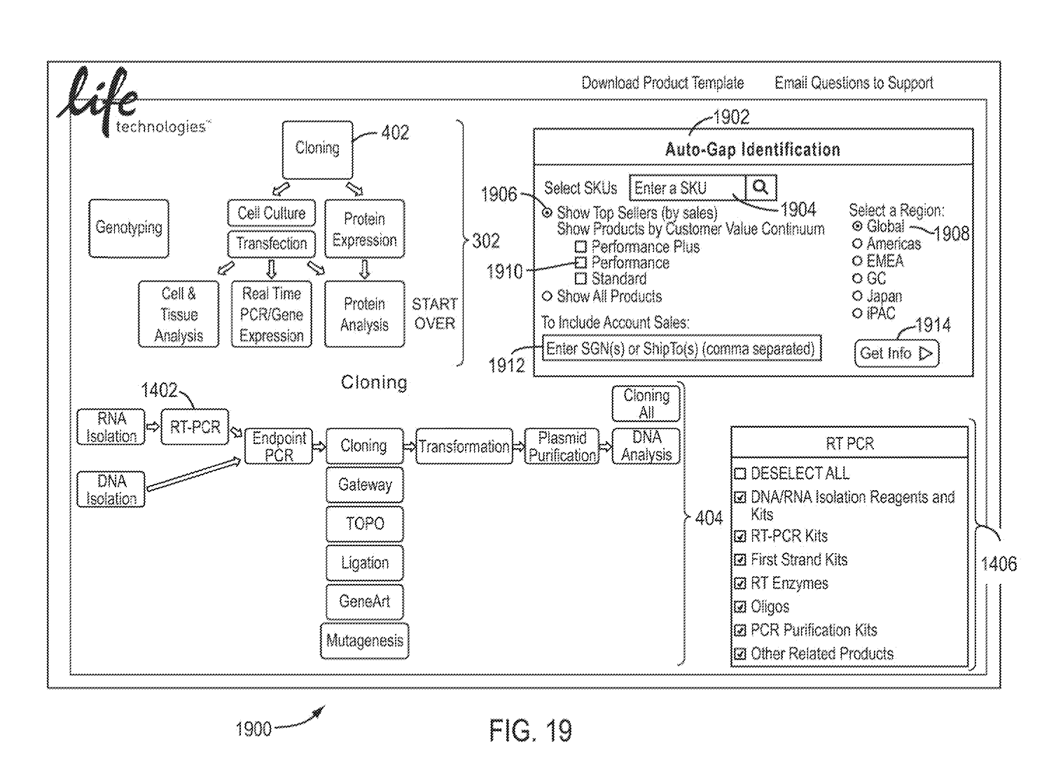

FIG. 19 illustrates an exemplary user interface 1900 displaying an exemplary auto-gap identification feature 1902. Using the auto-gap identification feature, product sales can be identified across the whole company, for a specific customer, or for a group of customers.

To use the auto-gap identification feature 1902, a user may desire information about product sales to a particular customer. The user may enter a product number, such as the SKU number, in search box 1904, and customer account number in input box 1910, to view potential gaps. Additionally, the user may narrow down the gap identification using several variables such as, but not limited to, top sellers SKUs 1906, region 1908, and/or Continuum Value Customer 1910.

The combination of search functions and filters may give the users flexibility to create a variety of customized reports and identify opportunities for cross-selling and/or up-selling easily and quickly.

Although various embodiments have been described with respect to certain exemplary embodiments, examples, and applications, it will be apparent to those skilled in the art that various modifications and changes may be made without departing from the present teachings.

What is claimed is:

1. A system for visualizing a plurality of data plots, the system comprising:
a processor; and
a memory encoded with instructions, executable by the processor, for:
receiving a selection of a desired workflow from a user, wherein the desired workflow includes a set of steps including at least one step;
receiving a selection of a step from the set of steps from the user;
displaying a plurality of product categories associated with the selected step;
receiving a selection of a product category of the plurality of product categories from the user;
displaying a plurality of products associated with the selected product category; and
displaying a plurality of associated metrics associated with each of the products of the plurality of products, wherein at least one of the associated metrics is determined from input from a plurality of users.

2. The computer-implemented method of claim 1, wherein the workflows are scientific experiment workflows.

3. The system of claim 1, wherein the instructions further include instructions for:
generating a recommendation for a product for the user.

4. The system of claim 3, wherein the instructions further comprise instructions for receiving user preferences, wherein user preferences are used to generate the recommendation for the user.

5. The system of claim 1, wherein the system is configured to be a portable device.

6. The system of claim 1, wherein the system is configured in a table computer.

7. The system of claim 1, wherein the system is configured in a mobile phone.

8. A computer-implemented method for determining a desired product for performing a workflow, the method comprising:
receiving a selection of a desired workflow from a user, wherein the desired workflow includes a set of steps including at least one step;
receiving a selection of a step from the set of steps from the user;
displaying a plurality of product categories associated with the selected step;
receiving a selection of a product category of the plurality of product categories from the user;
displaying a plurality of products associated with the selected product category; and
displaying a plurality of associated metrics associated with each of the products of the plurality of products, wherein at least one of the associated metrics is determined from input from a plurality of users.

9. The computer-implemented method of claim 8, wherein the workflows are scientific experiment workflows.

10. The computer-implemented method of claim 8, wherein the associated metrics associated with each of the products of the plurality of products is at least one of the following: associated workflow, sales rating, supply center recommendation, product features, storage temperature, similar product, competitor name, and competitor product name.

11. The computer-implemented method of claim 8, wherein the desired workflow is one of the following: cloning, transfection, cell culture, cell and tissue analysis, real time PCR, gene expression, protein analysis.

12. The computer-implemented method of claim 8, wherein the product categories include at least one of the following: reagents, kits, enzymes, oligos, and instruments.

13. A computer-readable medium encoded with instructions, executable by a processor, the instructions comprising instructions for:
receiving a selection of a desired workflow from a user, wherein the desired workflow includes a set of steps including at least one step;
receiving a selection of a step from the set of steps from the user;
displaying a plurality of product categories associated with the selected step;
receiving a selection of a product category of the plurality of product categories from the user;
displaying a plurality of products associated with the selected product category; and
displaying a plurality of associated metrics associated with each of the products of the plurality of products, wherein at least one of the associated metrics is determined from input from a plurality of users.

14. The computer-readable medium of claim 13, wherein the instructions further comprise instructions for:
determining a valid testing of a sample in the plurality of samples based on the histogram.

15. The computer-readable medium of claim 13, wherein the workflows are scientific experiment workflows.

16. The computer-readable medium of claim 13, wherein the associated metrics associated with each of the products of the plurality of products is at least one of the following: associated workflow, sales rating, supply center recommendation, product features, storage temperature, similar product, competitor name, and competitor product name.

17. The computer-readable medium of claim 13, wherein the desired workflow is one of the following: cloning, transfection, cell culture, cell and tissue analysis, real time PCR, gene expression, protein analysis.

18. The computer-readable medium of claim 13, wherein the product categories include at least one of the following: reagents, kits, enzymes, oligos, and instruments.
